(19) United States
(12) Patent Application Publication
(10) Pub. No.: US 2008/0076456 A1
(43) Pub. Date: Mar. 27, 2008

(54) MESSAGE SENDING/RECEIVING METHOD FOR MOBILE TERMINAL

(75) Inventors: Eui Hun JUNG, Suwon-si (KR); Hee Won Seo, Seoul (KR); Su Jin Lee, Suwon-si (KR); Jong Hi Sung, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/854,446

(22) Filed: Sep. 12, 2007

(30) Foreign Application Priority Data
Sep. 21, 2006 (KR) 2006-0091956

(51) Int. Cl. H04Q 7/20

(52) U.S. Cl. 455/466

(57) ABSTRACT

A message sending/receiving method for mobile terminals is disclosed. The method includes: sending a message having puzzle setting information as a puzzle message; receiving the puzzle message and setting a puzzle; and displaying, if the puzzle is solved, a message content of the puzzle message. As a result, the recipient user problem solving capacity is stimulated through puzzle solving, and provide a security function for messages.

### PRIORITY

This application claims priority to an application entitled “MESSAGE SENDING/RECEIVING METHOD FOR MOBILE TERMINAL” filed in the Korean Intellectual Property Office on Sep. 21, 2006 and assigned Serial No. 2006-0091956, the contents of which are incorporated herein by reference.

### BACKGROUND OF THE INVENTION

1. Field of the Invention

The present invention relates generally to a supplementary service for a mobile terminal and, more particularly, to a message sending/receiving method enabling users of mobile terminals to send and receive multimedia messages having puzzles.

2. Description of the Related Art

A multimedia messaging system provides a multimedia messaging service (MMS) that enables users to send and receive a message including multimedia objects such as still images, audios and videos. The multimedia messaging system performs more diverse functions than those of existing messaging systems such as voice messaging system and unified messaging system. The multimedia messaging system can be considered as a next generation service system capable of delivering electronic mails, faxes, voice mails, moving image news and moving image mails to subscribers.

Although the multimedia messaging system can perform diverse functions, it is currently underutilized as a transmission means for multimedia files. In addition, users tend to send private letters or memos using MMS, and a normal MMS message is readily displayed on a screen upon selection. However, selection of a received MMS message containing a private letter in public places may lead to inadvertent exposure of the private letter to other persons.

### SUMMARY OF THE INVENTION

The present invention has been made in view of the above problems, and an object of the present invention is to provide a message sending/receiving method that can improve a mobile terminal in stimulating the problem solving capacity of a user.

Another object of the present invention is to provide a message sending/receiving method for a mobile terminal that can offer a security function for received messages.

In accordance with an exemplary embodiment of the present invention, there is provided a message sending method for a mobile terminal, including composing a message; adding puzzle setting information to the composed message to form a puzzled message; and sending the puzzled message. Preferably, the adding puzzle setting information step includes: storing a puzzle image in a body field of the composed message; storing information on the puzzled image in a header field of the composed message; and storing a type flag indicating a puzzled message in the header field.

In accordance with another exemplary embodiment of the present invention, there is provided a message receiving method for a mobile terminal, including receiving a message; determining if the received message is a puzzled message; setting the puzzle, if the received message is a puzzled message; determining if the puzzle is solved; and displaying the message content of the received message if the puzzle is solved.

In accordance with another exemplary embodiment of the present invention, there is provided a message sending/receiving method for mobile terminals, including: sending a message having puzzle setting information as a puzzled message; receiving the puzzled message and setting the puzzle; and displaying the message content of the puzzled message if the puzzle is solved.

### BRIEF DESCRIPTION OF THE DRAWINGS

The above and other objects, features and advantages of the present invention will be more apparent from the following detailed description in conjunction with the accompanying drawings, in which:

FIG. 1 illustrates the usage state of a message sending/receiving method according to the present invention;

FIG. 2 illustrates the configuration of a mobile terminal capable of using the method of FIG. 1;

FIG. 3 is a flow chart of a message sending procedure of the method of FIG. 1;

FIGS. 4A and 4B are screen representations illustrating message composition;

FIG. 5 is a flow chart of a message receiving procedure of the method of FIG. 1; and

FIGS. 6A to 6C are screen representations for message viewing.

### DETAILED DESCRIPTION OF PREFERRED EMBODIMENTS

Exemplary embodiments of the present invention are described in detail with reference to the accompanying drawings. The same reference symbols identify the same or corresponding elements in the drawings. Detailed descriptions of constructions or processes known in the art may be omitted to avoid obscuring the invention in unnecessary detail.

The present invention relates to a message sending/receiving method for a mobile terminal. For the purpose of simplicity, a mobile communication terminal is used as an example of a communication device. The mobile terminal of the present invention is a terminal that can send and receive Multimedia Messaging Service (MMS) message, and may be any information and communication appliance or multimedia appliance, such as a mobile communication terminal, Digital Media Broadcast (DMB) receiving terminal, Personal Digital Assistant (PDA), International Mobile Telecommunications 2000 (IMT 2000) terminal, Wideband Code Division Multiple Access (WCDMA) terminal, and Universal Mobile Telecommunications System (UMTS) terminal.

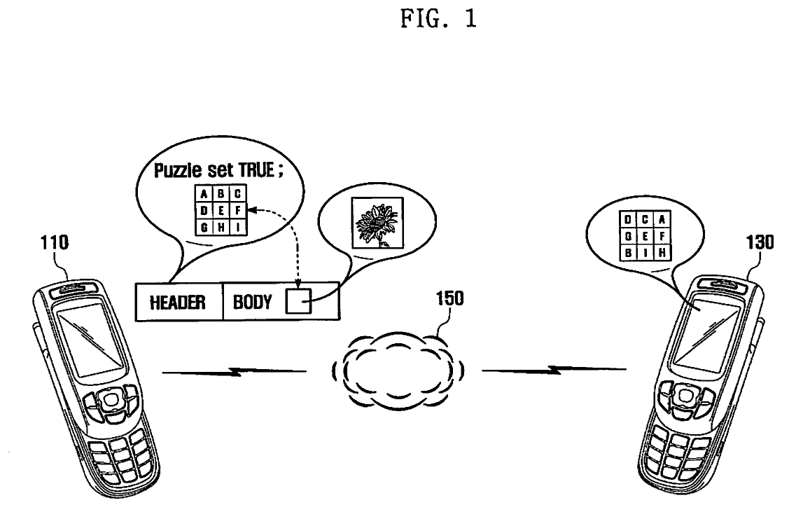

Referring to FIG. 1, mobile terminals may act as a sending mobile terminal 110 or a receiving mobile terminal 130. Sending mobile terminal 110 sends an MMS message via a mobile communication system 150 to receiving mobile terminal 130. Mobile communication system 150 relays MMS messages between mobile terminals. Sending mobile terminal 110 can also receive an MMS message, and receiving mobile terminal 130 can also send an MMS message.

Sending mobile terminal 110 stores in advance a text message composed by a sending user for an MMS message, and a multimedia file to be attached to the MMS message. The multimedia file may contain a still image, moving image, song, or audio material. In the present invention, message composition refers to both entering alphanumeric characters for the text message and attaching a multimedia file. Message content refers to a message text and attached multimedia file. The format of an MMS message can be divided into a header field, body field, and tail field, or into a header field and body field. The header field stores information such as a message identifier, sender identifier, recipient identifier, and recipient phone number. The body field stores a message content. Other necessary information may be stored in the tail field.

To compose an MMS message supporting a puzzle function, the sending user can select the image of a puzzle. The image may be a still image selected by the sending user or a default image stored in advance. The sending user can preset the default image, which may be a still image downloaded or photographed by a camera module of the mobile terminal. When a puzzle image is absent or not selected by the sending user, a default image is used as the puzzle image. The puzzle image is stored in the body field.

Puzzle setting information is added to the MMS message. In the description, an MMS message supporting a puzzle function is referred to as a puzzle message. The header field of a puzzle message includes a type flag indicating a puzzle message (for example, puzzle set TRUE). The header field further includes setting information of a puzzle image, such as a link to the puzzle image stored in the body field, the number of image segments of the puzzle image, and display positions of the image segments.

Sending mobile terminal 110 sends a composed puzzle message via mobile communication system 150 to receiving mobile terminal 130.

Mobile communication system 150 includes a base station, base station controller, mobile switching center, home location register, message service center, and packet data serving node. Mobile communication system 150 provides a wireless channel between sending mobile terminal 110 and receiving mobile terminal 130 for data communication, for example puzzle message transmission.

Receiving mobile terminal 130 receives a message via mobile communication system 150. When the receiving user tries to view the received message, receiving mobile terminal 130 checks a type flag in the header field to determine whether the received message is a puzzle message. If the received message is a puzzle message, an image of the puzzle is extracted from the body field and divided into the preset number of image segments. Then the image segments are displayed as a puzzle at positions on a screen different from the display positions stored in the header field. The receiving user cannot view the message content until the puzzle is solved. Thus, the received message is not inadvertently exposed to other persons, and puzzle solving gives pleasure to the receiving user.

As previously described, the mobile terminal may act as a sending mobile terminal or a receiving mobile terminal.

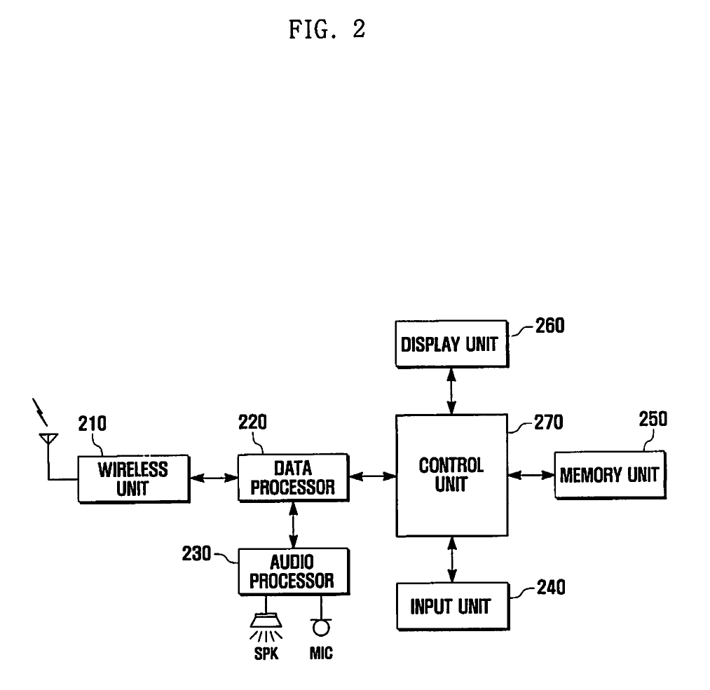

Referring to FIG. 2, the mobile terminal includes a wireless unit 210, data processor 220, audio processor 230, input unit 240, memory unit 250, display unit 260, and control unit 270.

Wireless unit 210 performs wireless communication operations for sending and receiving an MMS message or puzzle message to and from another mobile terminal, and for downloading a digital content from an external content server. Wireless unit 210 may include a radio frequency (RF) transmitter for upconverting the frequency of a signal to be transmitted and amplifying the signal, and an RF receiver for low-noise amplifying a received signal and downconverting the frequency of the received signal.

Data processor 220 processes audio data to and from audio processor 230, alphanumeric data from key input unit 240, and voice and other user data to and from wireless unit 210. Data processor 220 encodes and modulates a signal to be transmitted, and demodulates and decodes a received signal. Data processor 220 may include a modulator/demodulator (modem) and a coder/decoder (codec). The codec includes a data codec for processing packet data, and an audio codec for processing an audio signal such as a voice signal.

Audio processor 230 reproduces through a speaker SPK an audio signal from data processor 220, and outputs an audio signal from a microphone MIC to data processor 220, under the control of control unit 270.

Input unit 240 includes a plurality of alphanumeric and function keys for inputting alphanumeric information and for setting various functions. The function keys may include direction, side, and shortcut keys associated with corresponding functions. Input unit 240 transmits key signals from the user for setting and controlling the mobile terminal to control unit 270. In particular, the alphanumeric and function keys can be used for moving image segments to solve the puzzle of a puzzle message.

Memory unit 250 stores application programs necessary for utilization of the mobile terminal downloaded digital contents, and user-created data. Memory unit 250 provides a buffer space for processing MMS messages. Memory unit 250 may include a program memory section and a data memory section.

The program memory section stores the operating system for booting the mobile terminal, application programs for message processing, application programs for supplementary functions related to photographing and playing of audio and video data. When one of these functions is activated in response to a user request, the mobile terminal executes a corresponding application program under the control of control unit 270. The data memory section stores user data generating from operation of the mobile terminal. The data memory section stores various user data, such as default puzzle images, short message service (SMS) messages, MMS messages, digital contents including still images, audios and videos, setting information like a phonebook.

Display unit 260 displays various menus of the mobile terminal, information input by the user, and information to be provided to the user. Display unit 260 may include a panel of Liquid Crystal Display (LCD) devices. If the panel has a touch screen capability, display unit 260 can also act as an input means.

Controller 270 controls the overall operation of the mobile terminal, and signal exchange between internal components (wireless unit 210, data processor 220, audio processor 230, input unit 240, memory unit 250, and display unit 260). Controller 270 may include data processor 220.

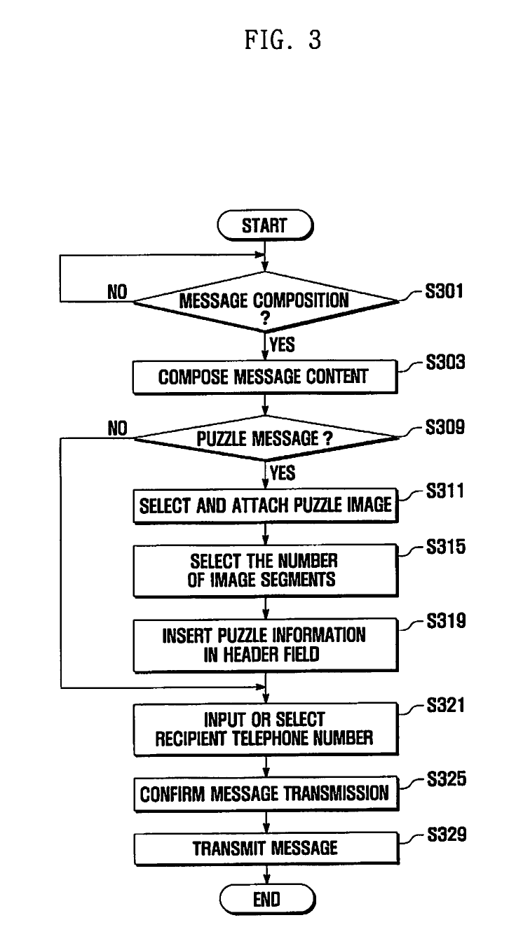

Referring to FIG. 3, when the sending user inputs a command key to compose a message in step S301, control unit 270 displays a message composition screen, and the sending user composes a message content using the message composition screen in step S303. The sending user can enter alphanumeric characters and attach a multimedia file such as a still image, video, and song and audio material.

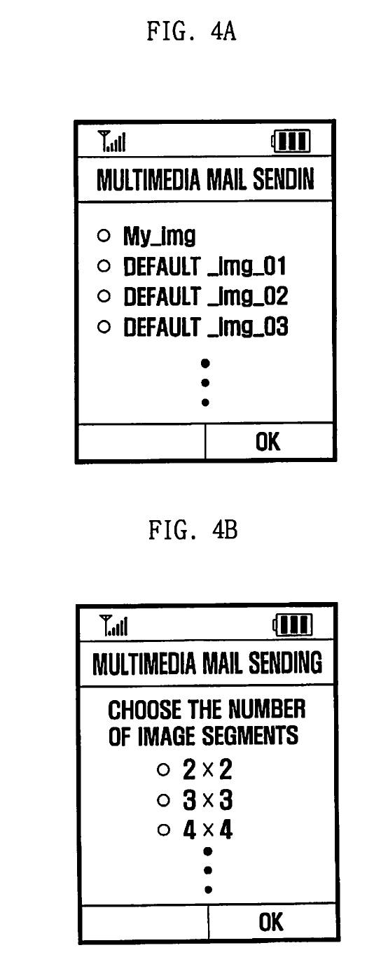

When the message content is completed, control unit 270 requests the sending user to decide whether to send a puzzle message in step S309. If the sending user decides to send a puzzle message, control unit 270 displays a selection screen for a puzzle image in step S311, as illustrated in FIG. 4A. The puzzle image may be a still image (My_img) attached by the sending user or one of pre-stored default images. For a higher security level, the sending user may select two or more puzzle images.

After puzzle image selection, control unit 270 displays a selection screen for the number of image segments in step S315, as illustrated in FIG. 4B. The number of image segments is related to the width-to-height ratio of the selected puzzle image. For a unitary ratio, the selected puzzle image may be divided into, for example, 2*2, 3*3, or 4*4 segments. For a non-unitary ratio, the selected puzzle image may be divided into, for example, 3*2, 4*3, or 5*4 segments. The number of image segments may be used for adjusting the security level of a puzzle message.

Thereafter, control unit 270 stores a link to the selected puzzle image, the number of image segments, display positions of the image segments, and a type flag indicating a puzzle message in the header field in step S319.

Control unit 270 displays an input screen for a recipient telephone number, and the sending user inputs or selects a recipient telephone number in step S321.

Control unit 270 displays a confirmation request screen for message transmission in step S325, and sends the composed message after user confirmation in step S329.

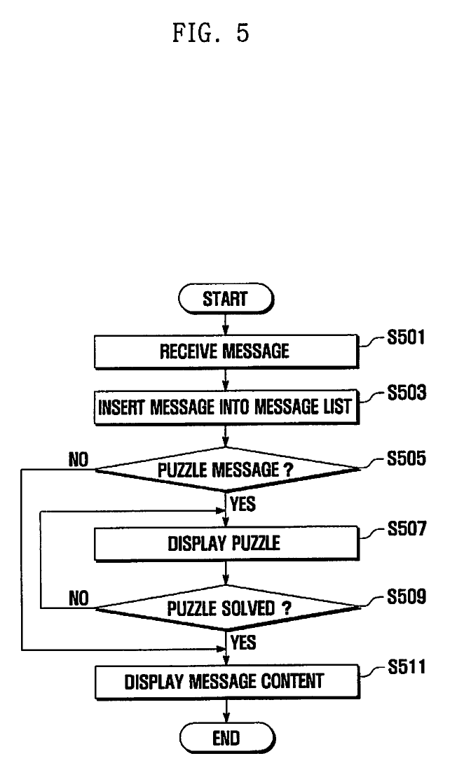

Referring to FIG. 5, when a message is received in step S501, control unit 270 issues a message arrival alert, and inserts the received message into a message list in step S503.

When the receiving user selects a message in the message list, control unit 270 checks a type flag in the header field of the selected message to determine whether the selected message is a puzzle message in step S505.

If the selected message is not a puzzle message, control unit 270 displays the content of the selected message through display unit 260 in step S511.

If the selected message is a puzzle message, control unit 270 sets a puzzle according to information in the header field, and displays the puzzle on a screen of display unit 260 in step S507. At step S507, control unit 270 extracts a puzzle image from the body field, divides the puzzle image into the preset number of image segments, displays the image segments at positions different from display positions stored in the header field.

Thereafter, the receiving user solves the puzzle, and control unit 270 determines if the puzzle is solved, by comparing the current positions of the image segments with the stored display positions in step S509. A procedure for puzzle solving is described as an example.

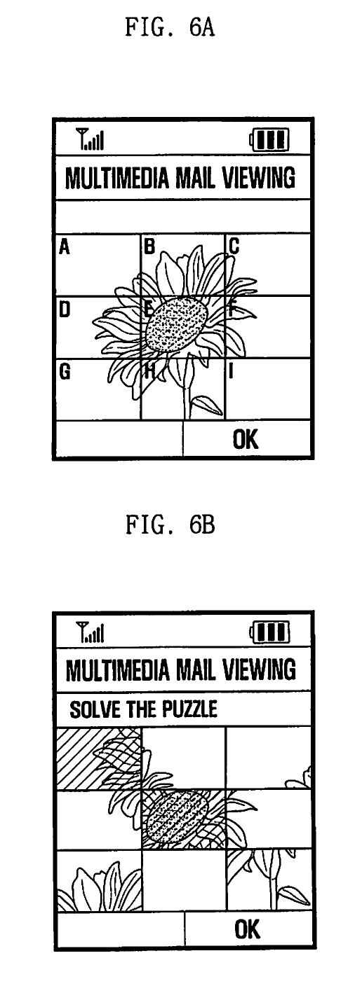

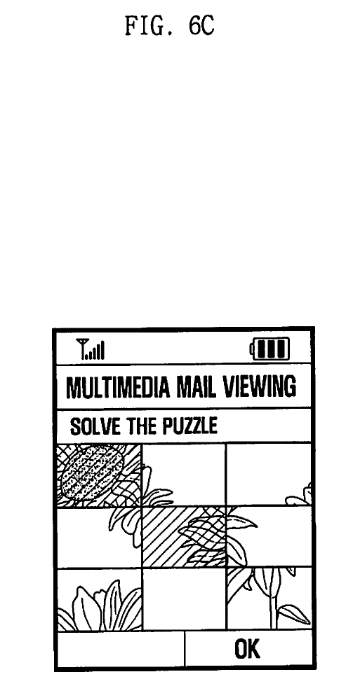

Referring to FIG. 6A, each image segment is preferably mapped to a numeric key. For example, an image segment ‘A’ is mapped to key ‘1’, and an image segment ‘E’ is mapped to a key ‘5’. When the user inputs in sequence numeric keys ‘1’ and ‘5’ in the state shown in FIG. 6B, the image segments ‘A’ and ‘E’ are exchanged with each other, as illustrated in FIG. 6C. The user can solve the puzzle by repeatedly exchanging two image segments.

Puzzle solving may be performed in various manners. For example, instead of exchanging two image segments, an image segment is temporarily removed, and then another image segment is moved to the position of the removed image segment. In addition, movement of image segments may be performed differently according to an input means. Further, a different puzzle may be set, wherein two identical puzzle images are divided into pairs of identical image segments, and then two image segments are repeatedly selected and matched to form a pair of identical image segments.

If the puzzle is solved, control unit 270 displays the content of the puzzle message through display unit 260 in step S511.

Accordingly, the content of a received puzzle message is displayed after an associated puzzle is solved. Because a puzzle message is not immediately disclosed, the puzzle message acts as a security-enforcing function. The security level can be adjusted on the basis of the number of puzzles to be solved and the number of image segments forming a puzzle image. Further, puzzle solving gives pleasure to a recipient user.

As is apparent from the above description, the present invention provides a message sending/receiving method for a mobile terminal that can stimulate the problem solving capacity of a recipient user through puzzle solving and offer a security function for a message.

While exemplary embodiments of the present invention have been shown and described in this specification, it will be understood by those skilled in the art that various changes or modifications of the embodiments are possible without departing from the spirit and scope of the invention as further defined by the appended claims.

What is claimed is:

1. A message sending method for a mobile terminal, comprising:
composing a message;
adding puzzle setting information to the composed message to form a puzzle message; and
sending the puzzle message.

2. The message sending method of claim 1, further comprising:
storing a puzzle image in a body field of the composed message;
storing information on the puzzle image in a header field of the composed message; and
storing a type flag indicating a puzzle message in the header field.

3. The message sending method of claim 2, wherein, if no still image is selected, at least one default still image is stored in the body field as the puzzle image.

4. The message sending method of claim 2 further comprising:
storing a link to the stored puzzle image;
storing the number of image segments for the stored puzzle image; and
storing display positions of the image segments.

5. The message sending method of claim 4, wherein the number of image segments is determined on the basis of a width-to-height ratio of the puzzle image.

6. The message sending method of claim 1, wherein at least one of a message text and a multimedia file is stored in a body field of the message.

7. A message receiving method for a mobile terminal, comprising:
receiving a message;
determining if the received message is a puzzle message;
setting, if the received message is a puzzle message, a puzzle;
determining if the puzzle is solved; and
displaying, if the puzzle is solved, a message content of the received message.

8. The message receiving method of claim 7, wherein puzzle message determination is performed through checking a type flag stored in a header field of the received message.

9. The message receiving method of claim 7 further comprising:
extracting a puzzle image from a body field of the received message using information in a header field of the received message;
dividing the extracted puzzle image into image segments, wherein the number of the image segments is the same as the number of image segments stored in the header field; and
displaying the image segments at positions of a screen different from display positions stored in the header field.

10. The message receiving method of claim 9 further comprising:
moving, in response to a signal input through an input unit, an image segment; and
determining whether the positions of the image segments are equal to the corresponding display positions stored in the header field.

11. The message receiving method of claim 10, wherein movement of an image segment is performed through entering in sequence a current position number of the image segment and a target position number.

12. The message receiving method of claim 7, further comprising displaying, if the received message is not a puzzle message, the message content of the received message.

13. A message sending/receiving method for mobile terminals, comprising:
sending a message having puzzle setting information as a puzzle message;
receiving the puzzle message and setting a puzzle; and
displaying, if the puzzle is solved, a message content of the puzzle message.
